(19) United States
(12) Patent Application Publication
(10) Pub. No.: US 2024/0286204 A1
(43) Pub. Date: Aug. 29, 2024

(54) COLLET CHUCK

(71) Applicant: FUJI CORPORATION, Chiryu (JP)

(72) Inventor: Toshitaka KIMURA, Nisshin-shi (JP)

(73) Assignee: FUJI CORPORATION, Chiryu (JP)

(21) Appl. No.: 18/294,396

(22) PCT Filed: Sep. 8, 2021
(86) PCT No.: PCT/JP2021/032943

§ 371 Date: Feb. 1, 2024

(51) Int. Cl. B23B 31/20; B23B 31/19

(52) U.S. Cl. CPC B23B 31/204; B23B 31/19

(57) ABSTRACT

A collet chuck including a mandrel, a first collet that is positioned outside the mandrel, an intermediate claw formed at each tip portion has an inner tapered surface formed on an inner side in sliding contact with the outer tapered surface of the mandrel, a second collet that is positioned outside the first collet, a chuck claw formed at each tip portion has an inner sliding contact surface formed on an inner side in sliding contact with an outer sliding contact surface formed on an outer side of the intermediate claw, and a chuck surface formed on an outer side of the chuck claw is brought into contact with a workpiece, and a collet support member that receives a force in an axial direction and supports the first collet movably in the axial direction.

### TECHNICAL FIELD

The present disclosure relates to a collet chuck that prevents a workpiece from being pulled in.

### BACKGROUND ART

A machine tool for machining a workpiece uses a chuck device for gripping the workpiece. As a chuck device for gripping an inner diameter hole of a workpiece, a collet chuck is used in which a mandrel is inserted into a collet having radial cuts from the center. The collet chuck expands and contracts the chuck claws of the collet in the radial direction by the tapered surfaces of both the mandrel and the collet which are in sliding contact with each other by the relative movement of the mandrel and the collet in the axial direction. For example, Patent Literature 1 below discloses a collet chuck of a type in which a mandrel side is moved in an axial direction. In the cylindrical collet, six slits are formed in a radial shape, and six expandable and contractible chuck claws are formed in the circumferential direction.

An inner tapered surface is formed on the chuck claw, and an outer tapered surface that is in sliding contact with the inner tapered surface of the chuck claw is formed at the tip portion of a drawbar (referred to as a mandrel in the present description). In a fixed collet chuck with the collet side fixed, the outer tapered surface retreats as the mandrel is pulled in the axial direction. At this time, the inner tapered surface of the collet is pushed outward, and each chuck claw expands to be pushed up against the inner diameter hole of the workpiece to clamp the workpiece. Meanwhile, the collet chuck includes a pulled-in collet chuck for pulling the collet side, and while the workpiece is being pulled in, the chuck claws expand by the tapered surface of the mandrel to clamp the workpiece.

### PATENT LITERATURE

Patent Literature 1: JP-A-2017-217744

### BRIEF SUMMARY

### Technical Problem

In the pulled-in collet chuck, the collet retreats while the chuck claws are pressed against a workpiece. Therefore, in the case of a workpiece having a relatively thin wall thickness, the workpiece is pulled in together during clamping, and the workpiece is further distorted. In this regard, since the mandrel moves instead of the collet, the fixed collet chuck can clamp the workpiece without pulling the workpiece. However, the fixed collet chuck is formed such that the outer taper of the mandrel increases in diameter toward the tip. Therefore, when the collet is pulled out from a collet chuck main body, the outer taper of the mandrel gets caught, and the structure does not allow for easy component replacement. In addition, since the mandrel positioned at the center moves, there is a disadvantage that the accuracy of centering is inferior to that of the pulled-in collet chuck to which the mandrel is fixed.

Therefore, an object of the present disclosure is to provide a collet chuck having double collets in order to solve this problem.

### Solution to Problem

A collet chuck according to an aspect of the present disclosure includes a mandrel on which a truncated conical outer tapered surface is formed at a tip portion and which is fixed at a center position, a first collet that is positioned outside the mandrel, in which a cylindrical collet main body is divided in a circumferential direction, and an intermediate claw formed at each tip portion of the collet main body section has an inner tapered surface formed on an inner side in sliding contact with the outer tapered surface of the mandrel, a second collet that is positioned outside the first collet, in which a cylindrical collet main body is divided in a circumferential direction, a chuck claw formed at each tip portion of the collet main body section has an inner sliding contact surface formed on an inner side in sliding contact with an outer sliding contact surface formed on an outer side of the intermediate claw, and a chuck surface formed on an outer side of the chuck claw is brought into contact with a workpiece, and a collet support member that receives a force in an axial direction and supports the first collet movably in the axial direction.

### Advantageous Effects

According to the above configuration, when the collet support member receives a force in the axial direction and moves the first collet in the axial direction, since the inner tapered surface of the intermediate claw formed on the first collet slides on the outer tapered surface of the mandrel fixed to the center position, and the intermediate claw expands in the radial direction depending on the taper angle, and further, the inner sliding contact surface of the chuck claw is in sliding contact with the outer sliding contact surface of the intermediate claw, the chuck claw is pushed outward and expands, it is possible to clamp a workpiece without moving the workpiece in the axial direction.

### BRIEF DESCRIPTION OF DRAWINGS

FIG. 1 is a cross-sectional view illustrating an embodiment of a collet chuck.

FIG. 2 is a simplified cross-sectional view illustrating the state of a chuck mechanism when the chuck mechanism is unclamped.

FIG. 3 is a simplified cross-sectional view illustrating the state of the chuck mechanism when the chuck mechanism is clamped.

### DESCRIPTION OF EMBODIMENTS

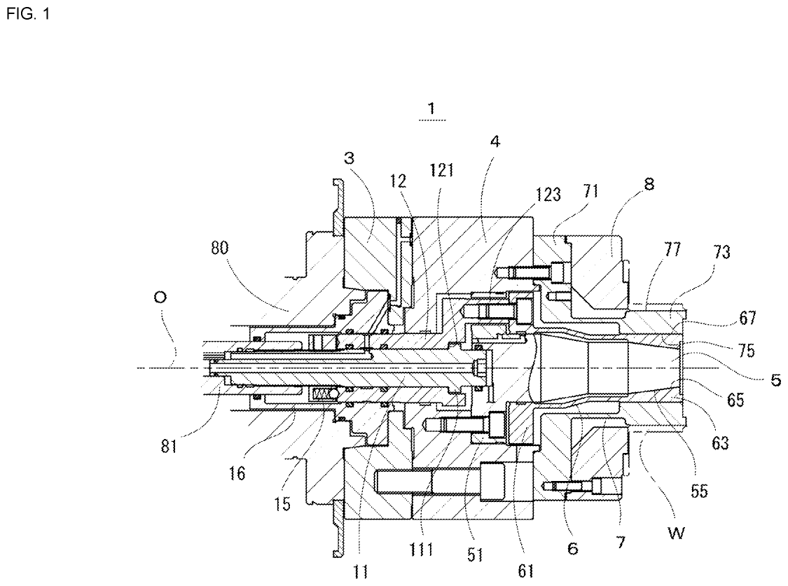

An embodiment of a collet chuck according to the present disclosure will be described below with reference to drawings. A machine tool is provided with a spindle device for gripping and rotating a workpiece, and various chuck devices are assembled to the spindle device in accordance with a target workpiece and processing contents. One of the chuck devices is a collet chuck that grips the inner diameter hole of a workpiece from the inside. FIG. 1 is a cross-sectional view illustrating a collet chuck of the present embodiment. Collet chuck 1 is assembled to rotating spindle 80 and constitutes the spindle device of the machine tool. Accordingly, center line O of the collet chuck overlaps the rotation axis of spindle 80.

In the collet chuck 1, base block 3 is stacked in the axial direction on the end of spindle 80 and fixed with screws, and main body block 4 is further stacked on base block 3 in the axial direction and fixed with screws. In collet chuck 1 of the present embodiment, a double collet chuck mechanism is assembled to main body block 4. In collet chuck 1, cylindrical mandrel 5 is fixed at the center position, first collet 6 movable in the axial direction is provided outside mandrel 5, and fixed second collet 7 is further disposed outside first collet 6.

Spindle 80 of the spindle device is rotatably assembled via a bearing, and is configured to rotate in response to an output from a servo motor. Drawbar 81 is inserted into the center hole of spindle 80 of the hollow shaft in the axial direction, and is connected to a piston rod of a hydraulic cylinder disposed coaxially. In collet chuck 1, operating rod 11 is incorporated at a center position coaxial with mandrel 5, and is connected to drawbar 81. Therefore, collet chuck 1 is configured such that operating rod 11 is displaced in the axial direction by the operation of the hydraulic cylinder. The left side of collet chuck 1 in the drawing is the rear side, and the same direction is the retraction direction of operating rod 11 by the hydraulic cylinder.

Operating rod 11 is inserted into cylindrical retracting member 12, and flange portion 111 protruding in the radial direction is brought into contact with stepped portion 121 formed on the inner side of retracting member 12 from the front side. Accordingly, as operating rod 11 moves rearward, retracting member 12 is pulled rearward via flange portion 111 hooked on stepped portion 121. Meanwhile, retracting member 12 is biased forward by spring 15, and is configured to be displaced forward as operating rod 11 moves forward.

Cylindrical holding member 16 is provided between base block 3 and spindle 80 such that the flange portions of holding member 16 are incorporated to engage with each other. Holding member 16 slidably holds retracting member 12 and drawbar 81, and is fixed to base block 3 with screws. Therefore, a collet support member that moves retracting member 12 in the front-rear direction via operating rod 11 connected to drawbar 81 is configured in the hollow portion formed in spindle 80, base block 3, and main body block 4.

In retracting member 12, connecting portion 123 that connects to first collet 6 in the axial direction is formed on the outer side of stepped portion 121 in the radial direction. Multiple connecting portions 123 are formed at equal intervals on the circumference, pass through through holes formed in flange portion 51 of mandrel 5, and are fixed to flange portion 61 of first collet 6 with screws. Meanwhile, flange portion 51 formed at the rear end of mandrel 5 is fixed to main body block 4 with screws.

In first collet 6, multiple radial slits are formed in a cylindrical collet main body, and intermediate claws 63 are formed at each tip portion of the collet main body divided in the circumferential direction by the slits. Truncated conical outer tapered surface 55 whose diameter decreases toward the front is formed at the tip portion part of mandrel 5, and the tapered surfaces of intermediate claws 63 of first collet 6 are in contact with the tip portion part of mandrel 5. Inner tapered surface 65 matching the angle of outer tapered surface 55 is formed on the inner side of intermediate claw 63, and inner tapered surface 65 slides on outer tapered surface 55 in a state of being in contact with outer tapered surface 55 as illustrated. The inner side of intermediate claw 63 of first collet 6 is a tapered surface inclined when viewed in the axial direction, but outer sliding contact surface 67 parallel to center line O is formed on the opposite outer side.

Flange portion 71 of second collet 7 disposed outside first collet 6 is fixed to main body block 4 with screws. In second collet 7, multiple slits are formed in a cylindrical collet main body section at equal intervals to those of first collet 6, and chuck claw 73 is formed at each tip portion of the collet main body divided in the circumferential direction by the slits. In chuck claw 73, inner sliding contact surface 75 parallel to center line O is formed on the inside so as to be in contact with outer sliding contact surface 67 of intermediate claw 63, and chuck surface 77 parallel to center line O is formed on the outside so as to be pressed against the inner diameter hole of workpiece W. Seating block 8 is fixed to flange portion 71 of second collet 7 with screws.

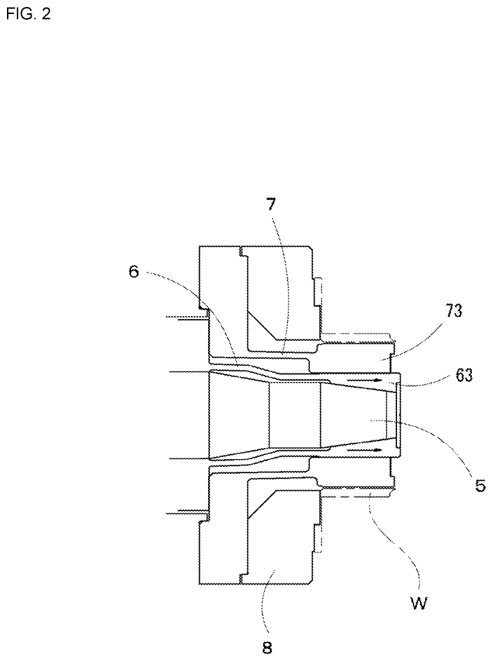

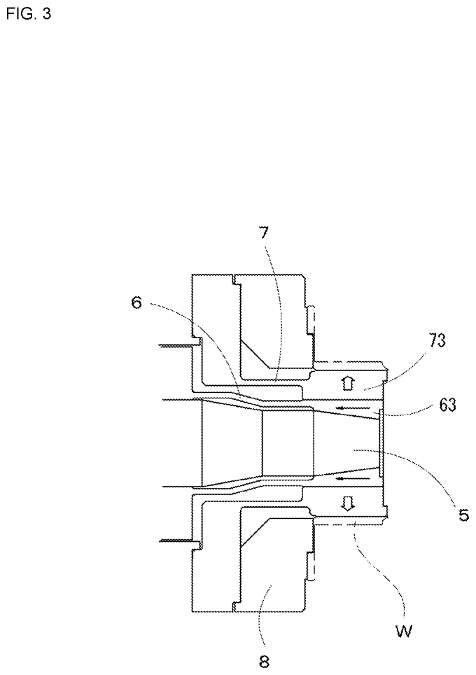

Next, FIGS. 2 and 3 are simplified cross-sectional views illustrating the chuck mechanism of collet chuck 1. In particular, FIG. 2 illustrates the state when the chuck mechanism is unclamped, and FIG. 3 illustrates the state when the chuck mechanism is clamped. The operation of collet chuck 1 will be described below with reference to FIG. 1. Collet chuck 1 clamps and unclamps workpiece W by operating a hydraulic cylinder that operates drawbar 81. In a normal state, drawbar 81 is in a position moved forward, and collet chuck 1 is in an unclamped state as illustrated in FIG. 2.

Workpiece W is attached to such collet chuck 1. Workpiece W is a thin-walled cylindrical component with flanges, and the cylindrical portion of the workpiece is fitted into chuck claw 73 of second collet 7, and the flange portions are abutted against the seating surface of seating block 8. In clamping of the workpiece, the hydraulic cylinder is operated, and operating rod 11 integrated with drawbar 81 is pulled rearward. Operating rod 11 is configured to use the biasing force of spring 15 to pull retracting member 12 via flange portion 111 hooked onto stepped portion 121. Therefore, first collet 6 connected to retracting member 12 moves rearward by a certain distance.

Pulled-in first collet 6 moves rearward as indicated by the arrow in FIG. 3, and intermediate claw 63 expands according to the taper angle as inner tapered surface 65 slides on outer tapered surface 55 of mandrel 5. Since intermediate claw 63 is in contact with chuck claw 73 of second collet 7 on the outside, when intermediate claw 63 slides on outer tapered surface 55 of mandrel 5, chuck claw 73 is displaced so as to be pushed outward as indicated by the white arrows. Workpiece W is clamped so that the cylindrical portion of the workpiece is grasped from the inside by expanded chuck claws 73.

Meanwhile, when the hydraulic cylinder operates in the reverse direction and operating rod 11 is pushed forward via drawbar 81, released retracting member 12 moves forward by biasing force of spring 15 and is positioned by hitting flange portion 111. To move retracting member 12 forward, intermediate claw 63 of first collet 6 is moved from the position indicated in FIG. 3 to the position indicated in FIG. 2 such that chuck claws 73, which have been pushed outward, are displaced inward and contracted and workpiece W is released and unclamped.

In collet chuck 1 of the present embodiment, since the chuck mechanism includes the double collets of first collet 6 and second collet 7, second collet 7 in contact with workpiece W does not move in the axial direction, and it is possible to avoid pulling workpiece W when clamping. Since workpiece W is no longer pulled in, even a workpiece having a relatively thin wall thickness is not distorted by the clamp, and the problem of lowering the machining accuracy by the machine tool can be solved.

In collet chuck 1 of the present embodiment, since intermediate claws 63 and chuck claws 73 are displaced along outer tapered surface 55 of mandrel 5 fixed at the center position, centering accuracy is high, and accurate clamping can be performed so that intermediate claws 63 and chuck claws 73 are coaxial with center line O of workpiece W. In addition, in collet chuck 1 of the present embodiment, since the tip portion part of mandrel 5 on which outer tapered surface 55 is formed has a truncated conical shape whose diameter decreases toward the front side, first collet 6 and second collet 7 are easily detached.

Although one embodiment of the present disclosure has been described, the present disclosure is not limited to the embodiment, and various modifications can be made without departing from the gist thereof.

For example, collet chuck 1 of the embodiment has been described as having a structure in which first collet 6 is pulled in to clamp a workpiece, but may have a structure in which the angles of outer tapered surface 55 and inner tapered surface 65 are changed to clamp a workpiece by extrusion.

### REFERENCE SIGNS LIST

1: collet chuck, 3: base block, 4: main body block, 5: mandrel, 6: first collet, 7: second collet, 11: operating rod, 12: retracting member, 55: outer tapered surface, 63: intermediate claw, 65: inner tapered surface, 67: outer sliding contact surface, 73: chuck claw, 75: inner sliding contact surface, 77: chuck surface

1. A collet chuck comprising:
a mandrel on which a truncated conical outer tapered surface is formed at a tip portion and which is fixed at a center position;
a first collet that is positioned outside the mandrel, in which a cylindrical collet main body section is divided in a circumferential direction, and an intermediate claw formed at each tip portion of the collect main body section has an inner tapered surface formed on an inner side in sliding contact with the outer tapered surface of the mandrel;
a second collet that is positioned outside the first collet, in which a cylindrical collet main body section is divided in a circumferential direction, a chuck claw formed at each tip portion of the collet main body section has an inner sliding contact surface formed on an inner side in sliding contact with an outer sliding contact surface formed on an outer side of the intermediate claw, and a chuck surface formed on an outer side of the chuck claw is brought into contact with a workpiece; and
a collet support member that receives a force in an axial direction and supports the first collet movably in the axial direction.

2. The collet chuck according to claim 1, wherein
the outer tapered surface of the mandrel and the inner tapered surface of the first collet are inclined surfaces such that diameters of the surfaces decrease toward a front side.

3. The collet chuck according to claim 1, wherein
the outer sliding contact surface formed on the intermediate claw of the first collet and the inner sliding contact surface formed on the chuck claw of the second collet are surfaces that are parallel to a center line.
